(19) United States
(12) Patent Application Publication
(10) Pub. No.: US 2010/0063866 A1
(43) Pub. Date: Mar. 11, 2010

(54) SERVICE PROVIDING METHOD, SERVICE PROCESSING DEVICE, AND MOBILE COMMUNICATING DEVICE

(76) Inventors: Masaki Kinoshita, Tokyo (JP); Kenichi Mogi, Tokyo (JP)

Correspondence Address: Tomoko Nakajima, 515 East Braddock Road, Alexandria, VA, 22314, US

(21) Appl. No.: 12/330,737

(22) Filed: Dec. 9, 2008

(30) Foreign Application Priority Data
Sep. 9, 2008 (JP) 2008-230987

(51) Int. Cl. G06Q 10/00; H04W 4/00; H04M 1/00

(52) U.S. Cl. 705/10; 455/426.1; 455/552.1

(57) ABSTRACT

A service providing method, wherein a mobile communication device changes surveyed questionnaire data to upper level category data and transfers the changed data to service processing device and Web server, the service processing device transfers place data around the service processing device to the Web server, the Web server selects advertisement data that matches user's attitudes and the place, based upon the surveyed questionnaire data and the place data, and the service processing device and the mobile communication device displays advertisement images corresponding to the advertisement data received from the Web server on a display.

This application is claims priority under 35 U.S.C. §119 to Japanese Patent Application No. 2008-230987, filed on Sep. 9, 2008, which is incorporated by reference.

### FIELD OF THE INVENTION

The present invention relates to a service providing method, a service processing device, and a mobile communication device that are used in a system to provide recommendation data such as advertisement data.

### BACKGROUND AND OBJECTS OF THE PRESENT INVENTION

Currently, various kinds of services are being provided by mobile communication devices like cellular phones. For example, users can use digital content data such as videos and music.

The mobile communication device includes an IC chip that enables short-range communication and reception of various data sent from a service processing device installed at a shop or other places. When the mobile communication device is put near the service processing device, it can receive a signal sent from the service processing device.

For mobile communication devices in this system, there are needs for presenting advertisements and others as recommendation data, which suits a place where the device is installed.

The system, however, has a problem that there is useless waiting time that users have to wait uselessly until communication between the mobile communication device and the service processing device completes.

An object of the present invention is to provide a service providing method, a service processing device, and a mobile communication device that can provide recommendation data such as advertisements, which suit a place where the device is installed, to a mobile communication device.

Another object of the present invention is to provide a service providing method, a service processing device, and a mobile communication device, which enable effective use of the waiting time while the service processing device installed at a predetermined place is performing short-range communication with the mobile communication device.

### SUMMARY OF THE INVENTION

The first aspect of the present invention is a service providing method using a mobile communication device having a short-range communication function, comprising the steps of: a first step in which the mobile communication device transfers user's or the mobile communication device's attribute data stored in the mobile communication device to a service processing device by performing short-range communication with the service processing device installed at a predetermined place.

The second aspect of the present invention is a service processing device comprising: an interface that performs short-range communication with a mobile communication device directly or indirectly; a memory that stores place data; and a controller that receives attribute data of a user or user's mobile communication device from user's mobile communication device, transfers the attribute data and the place data read out from the memory to the server, and performs announcement based upon recommendation data corresponding to the place data received from the server.

The third aspect of the present invention is a mobile communication device for performing short-range-communication with a service processing device installed at predetermined place, the mobile communication device comprising: a short-range communication interface that performs short-range-communication with the service processing device; a memory that stores attribute data of a user or his mobile communication device; and a controller that transfers the attribute data read out from the memory to the service processing device, receives recommendation data associated with the attribute data and a place of the service processing device, and performs announcement according to the recommendation data.

The fourth aspect of the present invention is a server for providing information associated with a mobile communication device that performs short-range communication with a service processing device installed at a predetermined place, the server comprising: an interface that receives attribute data of a user or his mobile communication device and place data of a place where the service processing device is installed from the mobile communication device or the service processing device; a memory that stores recommendation data which is associated with the attribute data and the place data; and a controller that reads out, from the memory, the recommendation data which is associated with the attribute data received by the interface and the place data, and transfers the recommendation data to the mobile communication device or the service processing device through the interface.

### BRIEF DESCRIPTION OF THE DRAWINGS

FIG. 1 is a schematic view of a communication system in accordance with a first embodiment of the present invention.

FIG. 2 is a block diagram of a cellular phone illustrated in FIG. 1.

FIG. 3 is a block diagram of a personal computer illustrated in FIG. 1.

FIG. 4 is a block diagram of a Web server illustrated in FIG. 1.

FIG. 5 is a flowchart of a first process of a communication system in accordance with a first embodiment of the present invention.

FIG. 6 is a flowchart of a second process of a communication system in accordance with a first embodiment of the present invention.

FIG. 7 is a flowchart of a first process of a communication system in accordance with a second embodiment of the present invention.

FIG. 8 is a flowchart of a first process of a communication system in accordance with a second embodiment of the present invention.

FIG. 9 is a flowchart of a second process of a communication system in accordance with a second embodiment of the present invention.

FIG. 10 is a flowchart of a third process of a communication system in accordance with a second embodiment of the present invention.

FIG. 11 is a schematic view of a communication system in accordance with a third embodiment of the present invention.

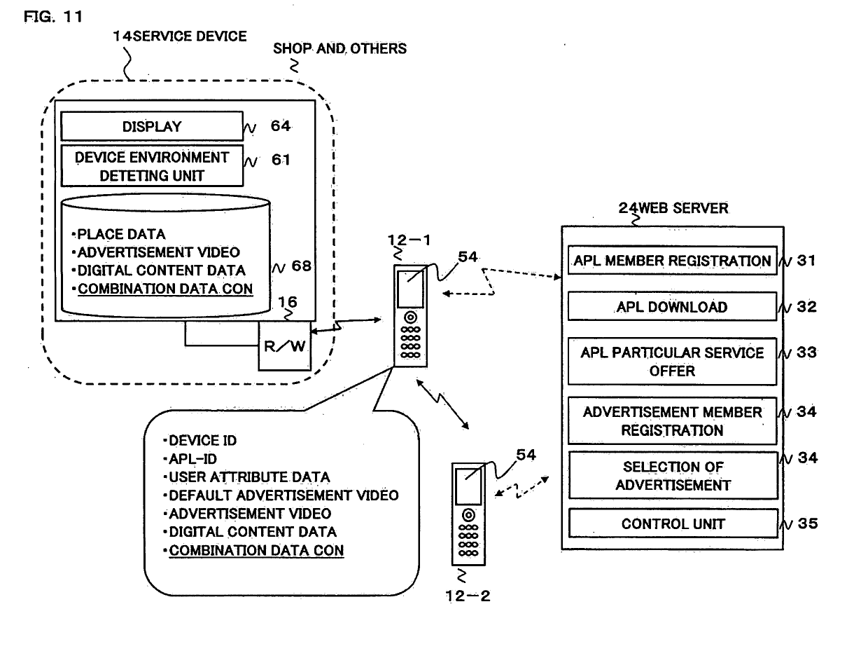

FIG. 12 is a schematic view of a communication system in accordance with a fourth embodiment of the present invention.

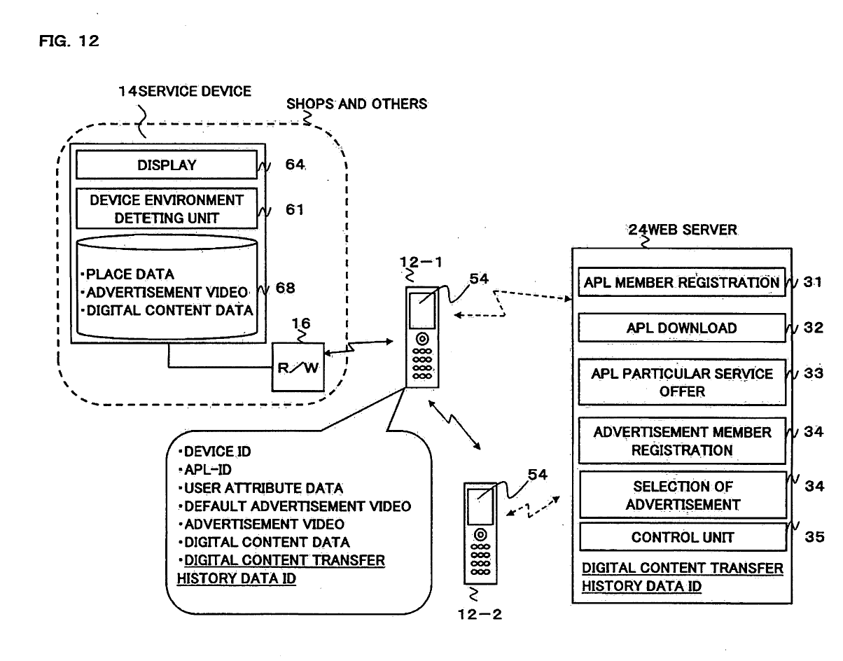

### DETAILED DESCRIPTION OF THE PRESENTLY PREFERRED EXEMPLARY EMBODIMENTS

### First Embodiment

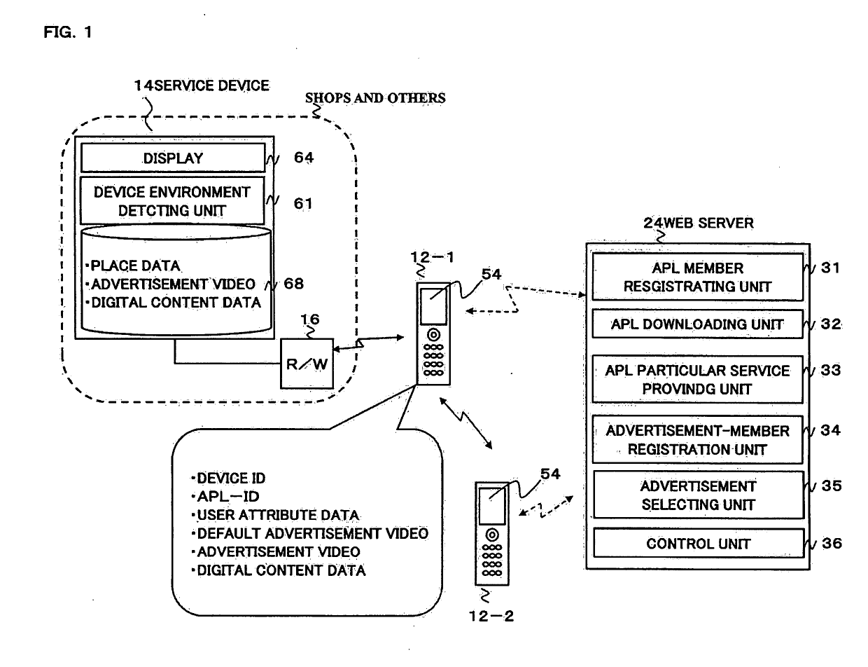

FIG. 1 is a schematic view of a communication system 1 in accordance with the first embodiment of the present invention. Referring to FIG. 1, the communication system 1, for example, includes cellular phones 12-1 and 12-2, a service device 14, an R/W device 16, and a Web server 24. In the communication system 1, the service device 14 and the R/W device 16 are, for example, installed in shops, station premises, and others.

In the present embodiment, although two cellular phones 12-1 and 12-2 are used, the number of cellular phones is not limited. Here, the cellular phones 12-1 or 12-2 is one example of a mobile communication device regarding the present invention, and the service device 14 is also an example of a service processing device regarding the present invention, and the Web server 24 is an example of a server regarding the present invention.

[Cellular phone 12-1, 12-2]

The cellular phones 12-1 and 12-2 have a capability to communicate with other devices through network communications. The cellular phones 12-1 and 12-2 are capable of connecting to the Internet. As communication networks used in the present mobile communication, methods of CDMA (Code Division Multiple Access), PDC (Personal Digital Cellular), PDC-P (PDC-Packet), and IMT-2000 are used.

The cellular phones 12-1 and 12-2 can perform short-range communication with the R/W device 16 at shops or venues where the R/W devices are installed if the cellular phone is put near the R/W device. A user can download content data from the R/W device 16.

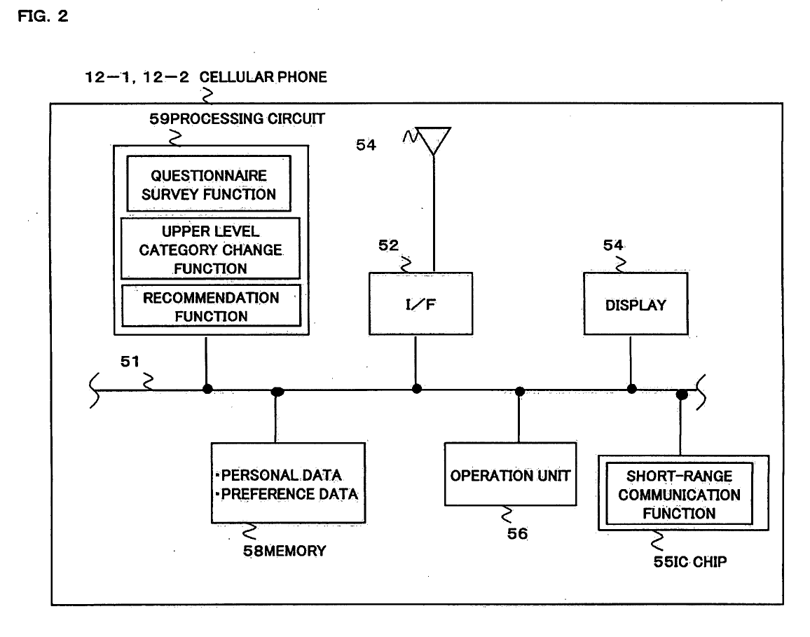

FIG. 2 is a block diagram of a cellular phone as shown n FIG. 1.

Referring to FIG. 2, the cellular phones 12-1 and 12-2 include, for example, a communication unit 52, a display 54, an operation unit 56, memory 58, and a processing circuit 59. The cellular phones 12-1 and 12-2 used in the present embodiment are operated by the processing circuit 59 that executes programs stored in the memory 58. At this time, data used in the execution is read out from or written to the memory 58.

The cellular phones 12-1 and 12-2 include an IC chip 55 that performs short-range communication by using a non-contact method, and the IC chip is given ICID that is unique identification information. In the present embodiment, for example, the cellular phones 12-1 and 12-2 perform short-range communication by using the IC chip 55. The IC chip 55 is a short-wave-resistant module. The IC chip 55 is removably or fixedly built in the cellular phones 12-1 and 12-2.

The processing circuit 59 displays a questionnaire page on the display 54 when a user operates the operation unit 56. The processing circuit 59 updates the questionnaire page according to user's filling of the questionnaire. The questionnaire contents include items useful for judging user's emotions.

The questionnaire may also include items such as color therapy, avatar doll, and horoscope.

The processing circuit 59 performs the process of changing the surveyed questionnaire data to upper level category data. Specifically, the processing circuit 59 changes the current-level data into upper level category data for the surveyed questionnaire data. For example, if the surveyed data is “address: Los Angels, favorite singer: Japanese rock singer, and favorite food: sushi”, then it is changed to upper level category data like this, “address: west coast, favorite singer: rock singer, and favorite food: Japanese food”. The above-mentioned category-level change, which is made by the processing circuit 59, uses a prepared correspondence table in which each word is associated with its upper level category word. The processing circuit 59, if desired, may also use one of a plurality of correspondence tables wherein each table has a different category level data. Thus a user can select a category level when he changes the present category level into an upper category level. Instead of using the cellular phones 12-1 and 12-2, mobile information devices such as mobile game machines and PDAs may also be used.

[Service Device]

The service device 14 includes, for example, a device environment detecting unit 61, an interface 62, a display 64, a short-range communication unit 65, a memory 68, and a processing circuit 69. The service device 14 is installed at a place such as a shop, and communicates with the cellular phone 12-1 via the R/W device 16. The device environment detecting unit 61generates, for example, environment data by examining the device environment where the service device 14 is installed. The device environment detecting unit 61 has, for example, temperature detecting function to detect the temperature of the above-mentioned environment with a temperature sensor, humidity detecting function to detect humidity with a humidity sensor, sound detecting function to detect sound with a microphone, and image detecting function to detect an image with a camera. The device environment detecting unit 61 generates sound data with the sound detecting function and image data with the image detecting function, and examines them, so that the device environment detecting unit 61 automatically generates environment data by examining items such as the number of people around the service device 14, a noise level, and gender of people. The operation of the service device 14 is controlled by the processing circuit 69. The memory 48 may be a removable semiconductor memory.

[R/W Device 16]

The R/W device 16 performs short-range communication with the cellular phone 12-1. Standards of protocol used in short-range communication include, for example, NFC (Near Field Communication), ISO/IEC 14443, Bluetooth, UWB (Ultra Wide Band), and IEEE802.11b. A method of the short-range communication in the present embodiment may be a contact method, or a non-contact method. The R/W device 16 is installed at a shop and other places.

[Web Server 24]

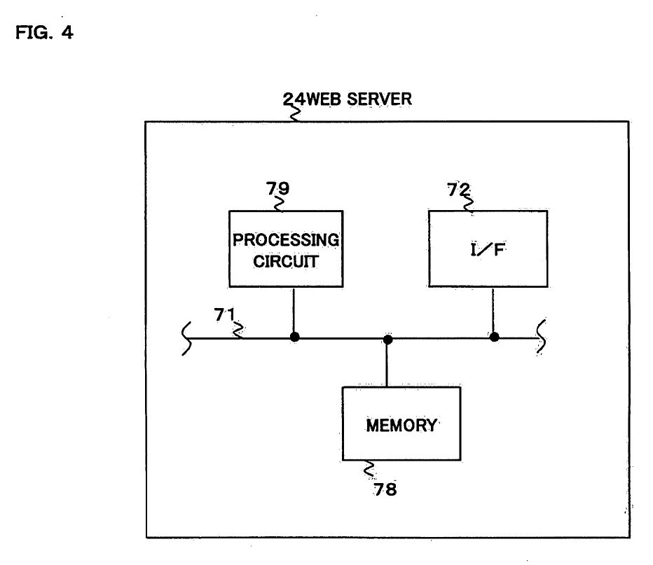

Referring to FIG. 4, the Web server 24 includes, for example, an interface 62, a memory 68, and a processing circuit 69. As shown in FIG. 1, the Web server 24 includes, for example, an APL member registration unit 31, an APL downloading unit 32, an APL particular service providing unit 33, an advertisement-member registration unit 34, an advertisement selecting unit 35, and a control unit 36. The APL member registration unit 31 performs member registration before an application program APL is downloaded, which will be described later. The APL downloading unit 32 downloads the above-mentioned application program APL.

The APL particular-service providing unit 33 provides services such as content selling service, shop searching service, and photo printing service by using the application program APL. The advertisement-member registration unit 34 registers members that use digital content data.

The advertisement selecting unit 35 selects suitable advertisement data from the advertisement data stored in the memory 78 based upon both the changed questionnaire data and place data that are transferred from the cellular phone 12-1. Specifically, the advertisement selecting unit 35 designates a tag corresponding to user's preference based upon the prepared correspondence table, in which tags are beforehand associated with user's preferences based upon the changed questionnaire data. And the advertisement selecting unit 35 also designates a tag corresponding to the above place based upon the prepared correspondence table. Then the advertisement selecting unit 35 selects a plurality of advertisement items having the above tags by searching advertisement data stored in the memory 78. The advertisement selecting unit 35 also selects advertisement data based upon both the place data and the environment data around the service device 14, as will be described later.

The control unit 36 implements a predetermined program stored in the memory 78 so as to control operation of Web server 24.

Each function of the Web server 24, as shown in FIG. 1, is performed when the processing circuit 69 implements a program stored in the memory 68. At this time, data used in this implementation is read out from or written into the memory 68.

The following explains the processes operated by the communication system 1 as shown in FIG. 1.

First Process

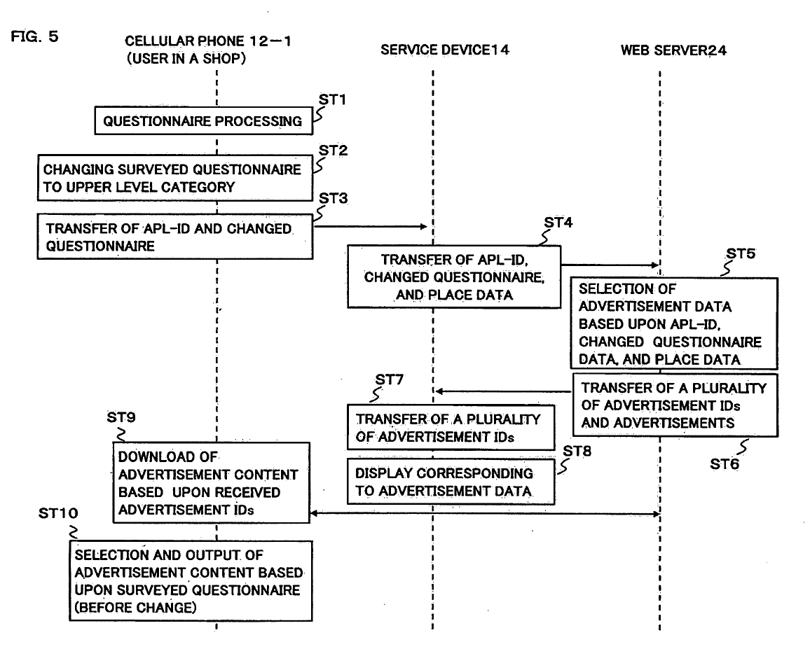

The first process is a process in which the communication system 1 of FIG. 1 performs delivery of advertisement content based upon the changed questionnaire data. FIG. 5 is a flowchart of the first process of the communication system 1 of FIG. 1.

STEP ST1:

The processing circuit 59 of the cellular phone 12-1 of FIG. 2 displays a questionnaire page on the display 54 when a user operates the operation unit 56. The processing circuit 59 updates the questionnaire page according to the progress of user's entry operation. The processing circuit 59 stores the entered questionnaire data in the memory 58.

STEP ST2:

The processing circuit 59 reads out the surveyed questionnaire data from the memory 58 and changes the words to upper level category words, as described above.

STEP ST3:

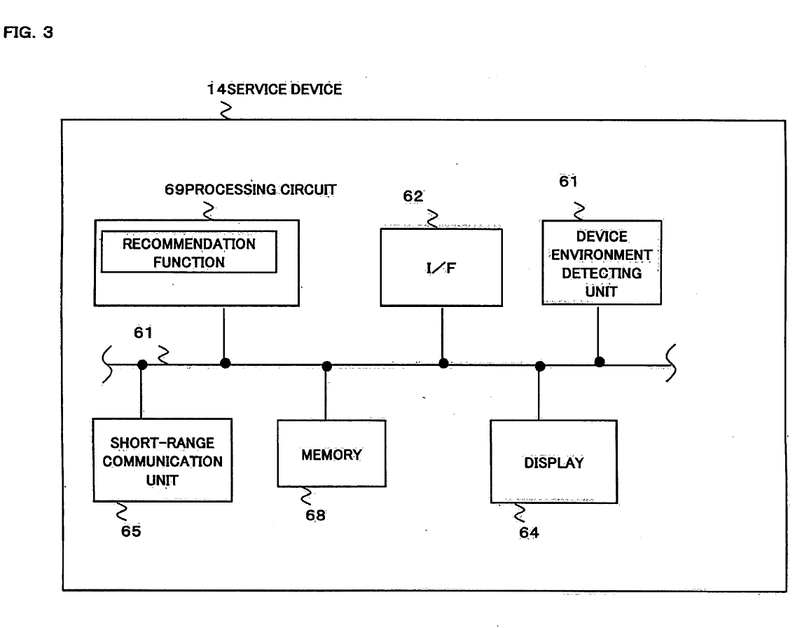

The processing circuit 59 transfers the changed questionnaire data produced in the step ST2 to the service device 14 through short-range communication operated by the IC chip 55. Then the service device 14 in FIG. 3 transfers the received changed-questionnaire data to the memory 68.

STEP ST4:

The processing circuit 69 of the service device 14 of FIG. 3 reads out the changed questionnaire data and the place data from the memory 68, and transfers them to the Web server 24 via the interface 62. Then the processing circuit 79 of the Web server 24 of FIG. 4 transfers the received changed-questionnaire data and the place data to the memory 68.

STEP ST5:

The processing circuit 79 of the Web server 24 selects suitable advertisement data from the advertisement data stored in the memory 78, based upon the changed questionnaire data and the place data. Specifically, the processing circuit 79 designates a tag corresponding user's preference based upon a prepared correspondence table, in which tags are beforehand associated with user's preferences based upon the changed questionnaire data. The processing circuit also designates a tag corresponding to the above place based upon the prepared correspondence table. Then the processing circuit 79 selects a plurality of advertisement items having the above tags by searching advertisement data stored in the memory 78. The processing circuit 79 may make the memory 78 store the histories of advertisement data previously selected by a user or his belonging group, so that the processing circuit 79 can select advertisement data according to the histories. Here, group classification may be performed by people's attributes such as students, adults, women, and men or by types of the cellular phones. Further, if the history data is made through short-range communication, the group may be people that has transferred the same content data.

STEP ST6:

The processing circuit 79 of the Web server 24 designates IDs of a plurality of advertisement items which are selected in step ST5, and transfers these IDs to the service device 14 via the interface 72. The processing circuit 69 of the service device 14 transfers a plurality of received IDs to the memory 68. In addition to the ID data, the processing circuit 79 reads out the advertisement data associated with the place data and transfers it to the service device 14. The processing circuit 69 of the service device 14 transfers received advertisement data to the memory 68.

STEP ST7:

The processing circuit 69 of the service device 14 reads out the plurality of IDs and transfers them to the cellular phone 12-1 via the short-range communication unit 65. The processing circuit 59 of the cellular phone 12-1 transfers the plurality of received IDs to the memory 58.

STEP ST8:

The processing circuit 69 of the service device 14 reads out the advertisement data recorded in the step ST6 and displays the corresponding images on the display 64.

STEP ST9:

By using the plurality of IDs received in step ST7, the processing circuit 59 of the cellular phone 12-1 downloads all the corresponding advertisement data from the Web server 24. It is possible to download them from servers other than the Web server 24.

STEP ST10:

Based upon user's personal information, user's preference information, and the pre-changed questionnaire data stored in the memory 58, the processing circuit 59 selects advertisement data suitable for the present user from the advertisement data downloaded in the step ST9. The processing circuit 59 displays images corresponding to the selected advertisement data on the display 54.

According to the above-mentioned first process, since the questionnaire data is sent to the service device 14 and the Web server 24 after the questionnaire data stored in the cellular phone 12-1 has been changed to the upper level category data, the selected advertisement data is not necessarily known to others, so that users can protect their privacy. Users also can get suitable advertisement data which reflects the surveyed questionnaire. Further according to the first process, while the cellular phone 12-1 has not so much communication capacity, it is merely necessary to communicate only small-capacity ID data between the cellular phone 12-1 and the service device 14. Therefore communication time becomes shorter. According to the first process, the cellular phone 12-1 receives the advertisement data from the Web server 24 via large-capacity transmission according to the received IDs from the service device 14, and the cellular phone 12-1 selects the advertisement data suitable for the user from the received advertisement data. Therefore, the Web server 24 does not accumulate information regarding treated advertisement data.

Second Process

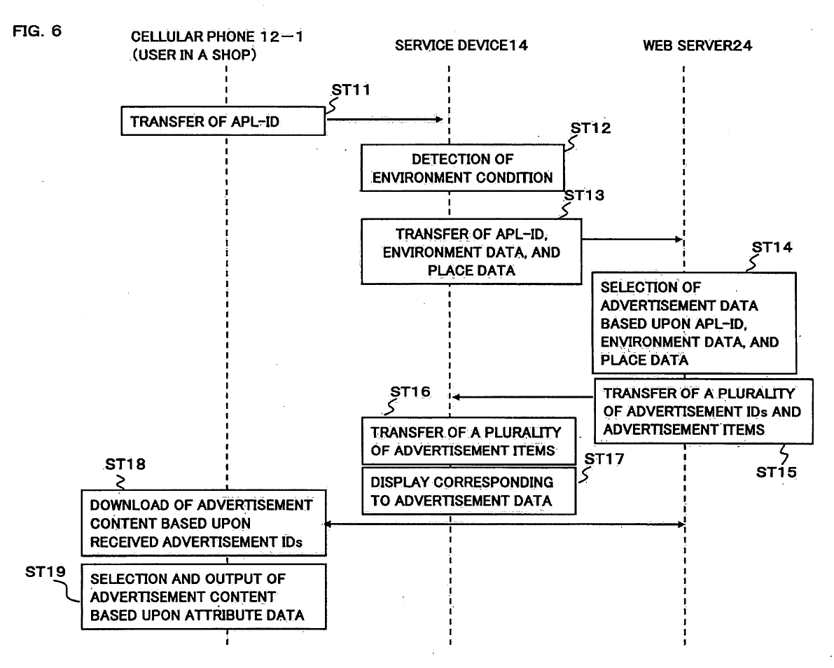

In the second process, the service device 14 generates environment data around itself, and advertisement data is selected based upon the environment data. FIG. 6 is a flowchart that explains the second process of the communication system 1 of FIG. 1.

STEP ST11:

The processing circuit 59 of the cellular phone 12-1 of FIG. 2 transfers an APL-ID, whose application is being implemented, to the service device 14 by using the short-range communication function of the IC chip 55. The service device 14 transfers the APL-ID received by the short-range communication unit 65 to the memory 68.

STEP ST12:

The device environment detecting unit 61 of the service device 14 examines the environment around the service device 14 and generates environment data, and then the generated environment data is transferred to the memory 68.

STEP ST13:

The processing circuit 69 of the service device 14 of FIG. 3 reads out the APL-ID, the environment data, and the place data from the memory 68, and transmits them to the Web server 24 via the interface 62. The processing circuit 79 of the server 24 of FIG. 4 transfers the received APL-ID, the environment data, and the place data to the memory 78. The processing circuit 69 of the service device 14 may also change the generated environment data to upper level category data and then transfer it to the Web server 24.

Thus in the second process, advertisement data can be selected based upon both the place data of the service device 14 and the automatically-generated environment data around the service device 14. Therefore a user can receive the advertisement to match his environment.

STEP ST14:

The processing circuit 79 of the Web server 24 selects suitable advertisement data from the advertisement data stored in the memory 78 based upon the APL-IDs, environment data, and the place data, which are read out from the memory 78. Specifically, the processing circuit 79 designates the corresponding tags based upon the prepared correspondence table, in which tags are beforehand associated with kinds of application program being implemented in the cellular phone 12-1, environments around the service device 14, and place data. And the processing circuit 79 selects a plurality of advertisements with the above tags by searching advertisement items stored in the memory 78.

The process of steps ST15 to ST19 is the same as the process of steps ST6 to ST10 of FIG. 5.

In the first process and the second process, though the advertisement data is used as recommendation data, the following data may be used as recommendation data. For example, the processing circuit 79 of the Web server 24 designates degree of fatigue, or kinds of emotions such as delight, anger, sorrow, and pleasure based upon the changed questionnaire data. And the processing circuit 79 selects various recommendation data based upon a kind of application program, the designated degree of fatigue, the designated kind of the emotion, and place data. Further, in the case where the cellular phone 12-1 is implementing a karaoke application, if user's feeling is designated as “pleasure”, the processing circuit 79 may recommend a pleasurable music. Further, in the case where the cellular phone 12-1 is implementing an application regarding transportation, if user's feeling is designated as “fatigue”, the processing circuit 79 may recommend a transportation route that probably provides a train seat on the way to home. Further, in the case where the cellular phone 12-1 is implementing an application regarding a theme park, if user's feeling is designated as “anger”, the processing circuit 79 may recommend a ride on which a user can blow off anger. Further, in the case where the cellular phone 12-1 is implementing an application regarding DVD rental, if user's feeling is designated as “fatigue”, the processing circuit 79 may recommend an easy movie. And if user's feeling is designated as “anger”, the processing circuit 79 may recommend a violent movie. Further, in addition to the emotions such as delight, anger, sorrow, and pleasure, atmosphere may be used when the processing circuit 79 recommends something. The processing circuit 79 may also recommend a thing suitable for going-home time based upon the place data and the time data.

The processing circuit 79 may assigns a certain atmosphere to the environment around the service device 14 based upon at least one of sound data and image data generated by the device environment detecting unit 61. For example, the processing circuit 79 assigns to the environment an atmosphere that many people are laughing, or an atmosphere that it is quiet even though many people are there.

Further, instead of using the environment data, word-of-mouth information, which is obtained by the Web server 24 via networks, may be used to select the advertisement data, or both of the word-of-mouth information and the environment data may be used. Further, a display installed in a train may be used as the service device 14. In this case, the Web server 24 may provide event information regarding stations, which are from the next station to the terminal, based on the information on the railroad lines and the present position, when the cellular phone 12-1 is put near the display. Further, in addition to the place data of the service device 14, based upon time information, various things may be recommended. Further, the Web server 24 may transfer recommendation data directly to the cellular phone 12-1. Further, the service device 14 may select recommendation data which is sent from the Web server 24. In this selection, the service device 14 may store a history of advertisement data, which each user or a group of users has selected before, into the memory 68, and may use the history to select advertisement data. For example, when the service device 14 communicates with the cellular phone 12-1 through short-range communication, the attribute data is received and changed to upper level category data. If the service device 14 finds that a user is the eleventh person and past 10 persons are women based upon the changed attribute data, the advertisement to display may be for women. Thus the service device 14 can increase advertisement effect by using attribute data.

### Second Embodiment

This embodiment will explain processes in which advertisement video is displayed on the displays of the cellular phone 12-1 and the service device 14 while they are communicating with each other.

First Process

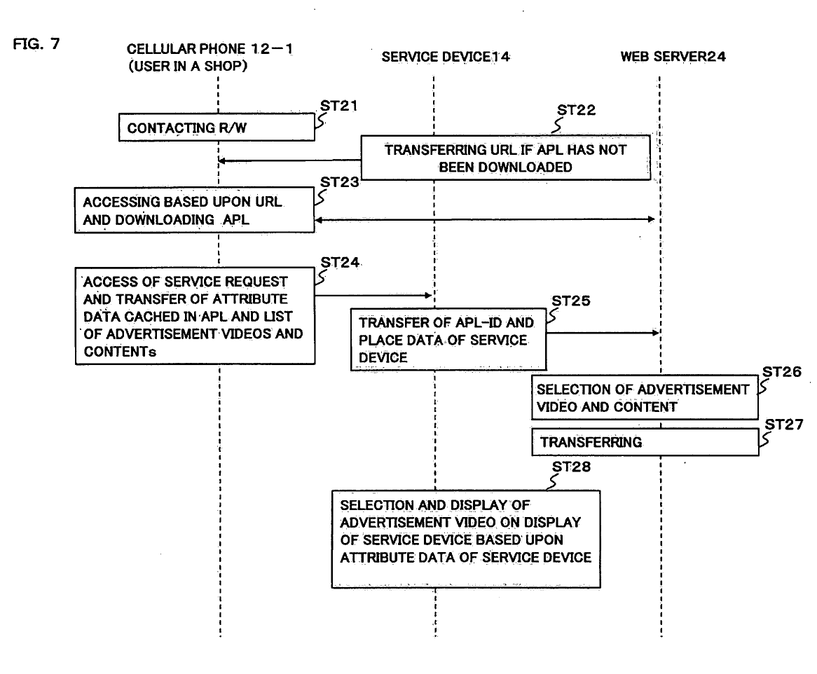

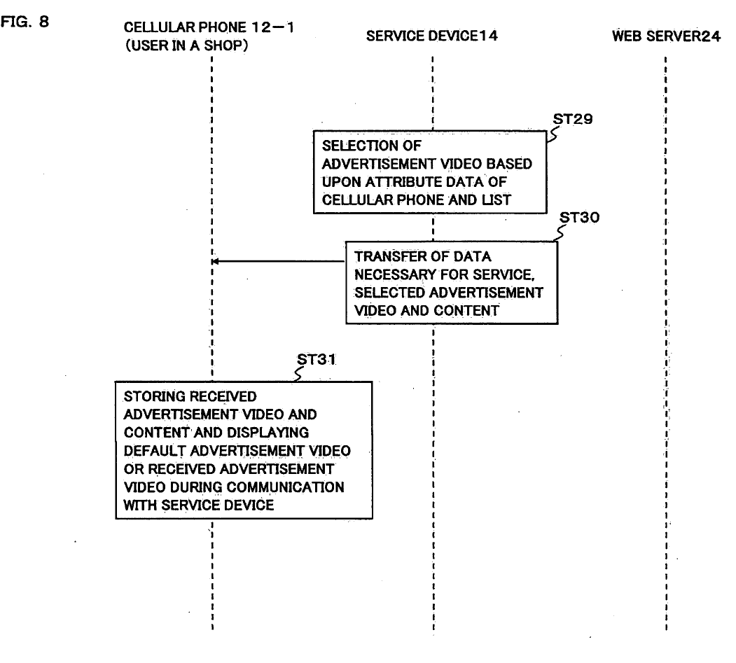

FIGS. 7 and 8 are flowcharts of a first process of a communication system in accordance with a second embodiment of the present invention.

STEP ST21:

When a user goes to a shop or a station, he can approach the R/W device 16 installed there and make the cellular phone 12-1 contact with the R/W device 16. By doing this, the R/W device 16 can communicate with the cellular phone 12-1 through short-range communication.

STEP ST22:

The service device 14 determines whether the cellular phone 12-1 has downloaded a predetermined application program APL through the R/W device 16. If the application program APL has not been downloaded, URL for downloading the application program APL is transferred to the cellular phone 12-1. An application program APL is, for example, provided to each service of the service device 14.

STEP ST23:

The cellular phone 12-1 accesses the Web server 24 by using the URL received in the step ST12 and downloads an application program APL. The cellular phone 12-1 transfers the application program APL to the memory 58 of FIG. 2. The application program APL includes a default advertisement video. In the present embodiment, the default advertisement video has no digital content data. In the present embodiment, the number of videos included in the cellular phones 12-1 and 12-2 is not limited.

When a user receives a particular service from the service device 14 by using the cellular phone 12-1, the processing circuit 59 reads out the application program APL from the memory 58 and starts it. Staring the application program APL, the processing circuit 59 reads out an advertisement video from the memory 58 and plays it on the display 54.

STEP ST24

The cellular phone 12-1 communicates with the service device 14 via the R/W device 16 by using the function of the application program APL. At this time, the cellular phone 12-1 transfers attribute data and a list of advertisement videos and digital content data, which are stored in the memory 58 of FIG. 2, to the service device 14, as well as given service requests. The service device 14 transfers the above things received from the cellular phone 12-1 to the memory 68 of FIG. 3. The attribute data includes, for example, user's age, gender, and preferences.

STEP ST25:

The processing circuit 69 of the service device 14 of FIG. 3 reads out APL-IDs and the place data from the memory 68 and transfers them to the Web server 24 via the interface 62. The processing 79 of the Web server 24 of FIG. 4 receives APL-IDs and transfers them to the memory 78.

STEP ST26:

The processing circuit 79 of the Web server 24 reads out APL-IDs and the place data from the memory 78, and based upon both of them the processing circuit 79 selects suitable advertisement from the advertisement stored in the memory 78. That is, the processing circuit 79, based upon both of a type of application program being implemented by the cellular phone 12-1 and a place of the service device 14, searches the corresponding advertisement videos and digital content data in the memory 78. The advertisement video is associated with the digital content data in a one-to-one correspondence, and both are assigned a type of application program and place data.

STEP ST27:

The processing circuit 79 of the Web server 24 transfers the advertisement videos and the digital content data selected in the step ST26 to the service device 14 via the interface 72. The processing circuit 69 of the service device 14 transfers the received advertisement videos and the digital content data to the memory 68.

STEP ST28:

The service device 14 reads out the advertisement videos, which match preferences of a user carrying the cellular phone 12-1, from the memory 68 of the FIG. 3 based upon the attribute data received in step ST24, and starts to play them on the display 64. At this time the service device 14 may make an advertisement video synchronize with advertisement voice (sound).

STEP ST29:

The service device 14 selects advertisement videos and digital content data to be transferred to the cellular phone 12 based upon the attribute data and the list of advertisement videos and digital content data received in the step ST24. Specifically, the processing circuit 69 of the service device 14, based upon the attribute data received from the cellular phone 12-1, makes a list satisfying preferences of the user carrying the cellular phone 12-1 by searching the list of the advertisement videos and digital content data that are stored in the memory 68. Then, from the list made in this step, the processing circuit 69 selects advertisement videos and digital content data that are not found in the list received from the cellular phone 12-1.

STEP ST30:

The processing circuit 69 of the service device 14 reads out, from the memory 68, data necessary for answering the service requests received in the step ST24. Then the service device 14 transfers the data necessary for the service requests and both the advertisement videos and digital content data selected in the step ST29 to the cellular phone 12-1 via the R/W device 16. At this time the advertisement videos are associated with the digital content data in one-to-one correspondence. The digital content data includes, for example, live videos, animation videos, ring tones, and standby screens. The digital video data is available on condition that users of the cellular phones 12-1 and 12-2 are registered as a member in the Web server 24. Transferring data to the cellular phone 12-1, the service device 14 displays an advertisement video on the display 64.

Each of digital content data is associated with licensing data defining licensing conditions. When a user uses digital content data, the processing circuit 59 of the cellular phone 12-1 determines whether the user can use digital content data based upon the licensing data associated with the digital content data. The cellular phone 12-1 transfers the received various data to the memory 58.

STEP ST31:

The processing circuit 59 of the cellular phone 12-1 displays the default advertisement video on the display 54 until the processing circuit 59 completes the reception of advertisement videos from the service device 14. The processing circuit 59 displays the received advertisement video on the display 54 when the reception of the advertisement video completes. The processing circuit 59 displays a plurality of advertisement videos in predetermined order when a plurality of advertisement videos are stored in the memory 58. In this case the processing circuit 59 may display a plurality of advertisement videos in priority order that is based upon the attribute data of the user carrying the cellular phone 12-1.

Second Process

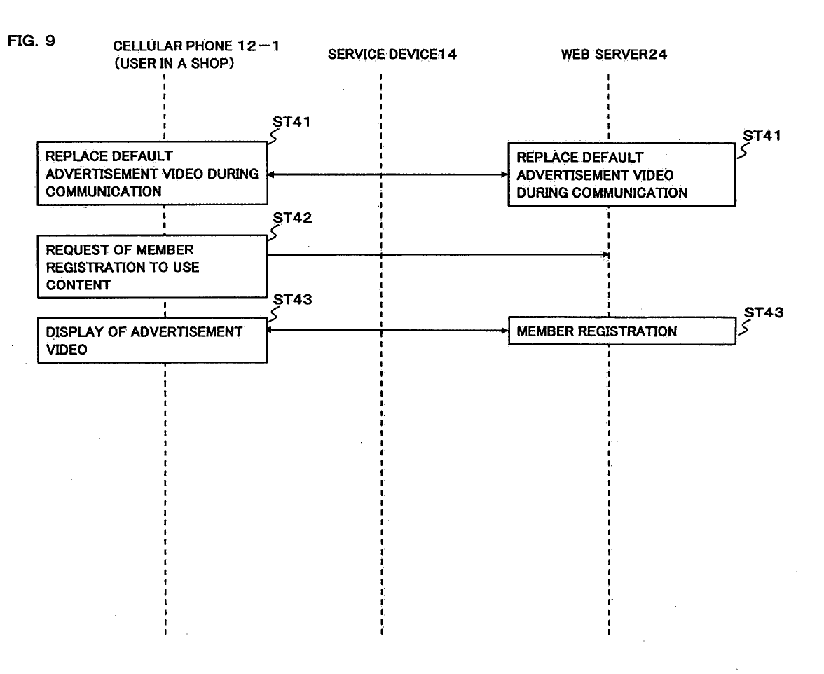

In the second process, the cellular phone 12-1 communicates with the Web server 24 after completion of the above-mentioned first process. FIG. 9 is a flowchart of a second process of a communication system 1 in accordance with a second embodiment of the present invention.

STEP ST41:

The cellular phone 12-1 accesses, for example, the Web server 24 according to user's operation of the operation unit 56. This access makes the processing circuit 79 of the Web server 24 read out the default video from the memory 78 and transfer it to the cellular phone 12-1. In the default video, an advertising area on the screen is located at, for example, the top of a page. At this time, the Web server 24 receives the attribute data from the cellular phone 12-1 and selects a default video that matches user's preference based upon the attribute data, and transfers the default video to the cellular phone 12-1. The cellular phone 12-1 transfers the default video, which is received from the Web server 24, to the memory 58 of FIG. 2.

STEP ST42:

The cellular phone 12-1 transfers a member registration request to the Web server 24 in order to use digital content data associated with an advertisement video.

STEP ST43:

The Web server 24 performs the member registration of the user or his cellular phone 12-1 according to the member registration request sent from the cellular phone 12-1. During this registration process, the processing circuit 59 of the cellular phone 12-1 reads out the advertisement video from the memory 58 and plays it on the display 54. In this registration process, the cellular phone 12-1 transfers data such as age, gender, preference, and local information to the Web server 24 to register them.

Third Process

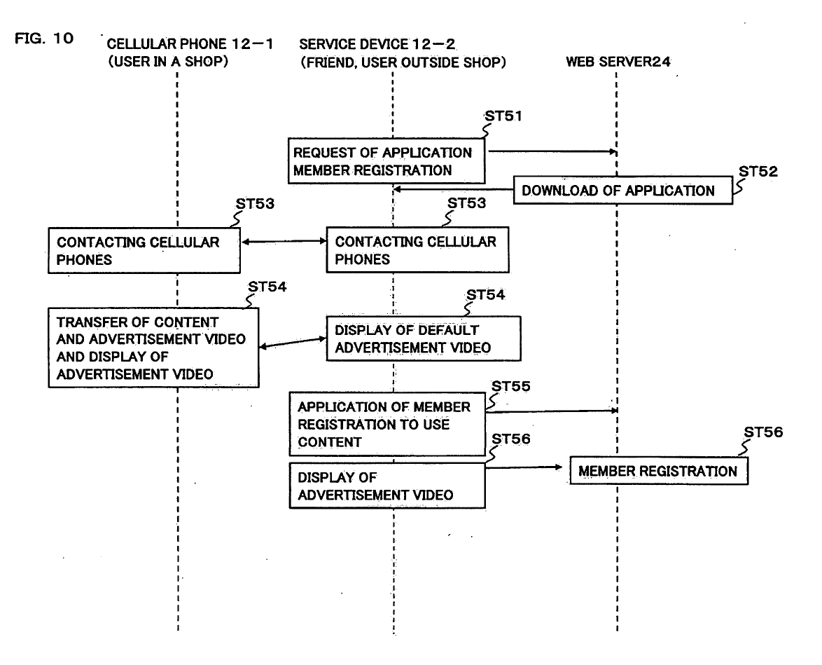

In the third process, the cellular phone 12-1 carried by a user in a shop communicates with the cellular phone 12-2 carried by his friend. FIG. 10 is a flowchart of a third process of a communication system I in accordance with a second embodiment of the present invention.

STEP ST51:

A user's friend, who is not in a shop, sends a member registration request to the web server 24 by using his cellular phone 12-2 in order to use an application program APL. If the cellular phone 12-2 has already downloaded the application program APL, the present process is not necessary.

STEP ST52:

The Web server 24 performs member registration according to the above member registration request and uploads the application program APL to the cellular phone 12-2. The cellular phone 12-2 transfers the application program APL to the memory 58 of the FIG. 2.

STEP ST53:

If digital content data that a user of the cellular phone 12-2 is interested in is stored in the cellular phone 12-1, short-range communication is performed by contacting the cellular phone 12-1 and the cellular phone 12-2. At this time, the cellular phone 12-1 designates the advertisement video and digital content data to send them to the cellular phone 12-2.

STEP ST54:

The cellular phone 12-1 reads out the designated advertisement video and digital content data from the memory 58 of FIG. 2 and transfers them to the cellular phone 12-2 via short-range communication. The cellular phone 12-2 transfers the received advertisement video and digital content data to the memory 58 of FIG. 2. During this communication, the cellular phone 12-1 reads out an advertisement video from the memory 58 and plays it on the display 54. Also during this communication, the cellular phone 12-2 reads out default images from the memory 58 and plays it on the display 54.

STEP ST55:

A user of the cellular phone 12-2 transfers a member registration request to the Web server 24 in order to use the digital video data received in the step ST 25.

STEP ST56:

The Web server 24 performs member registration of the cellular phone 12-2 or its user according to the request from the cellular phone 12-2. During this process, the processing circuit 59 of the cellular phone 12-2 reads out the advertisement video from the memory 58 and plays it on the display 54. Thus it becomes possible for the cellular phone 12-2 to use the received digital content data stored in the memory 58. The cellular phone 12-2 reads out the above digital content data from the memory 58 and plays it according to user's operation.

As described above, in accordance with the communication system 1 of the present invention, while the cellular phone 12-1 is communicating with the service device 14 via the R/W device 16, advertisement videos are displayed on the displays 54 and 64 of the cellular phone 12-1 and the service device 14 respectively. Therefore, the user of the cellular phone 12-1 can see the advertisement videos displayed on the displays 54 and 64 despite the waiting time, so that advertisement effects become higher.

Further, in accordance with the communication system 1 of the present invention, the advertisement videos are selected based upon attributes of the cellular phone 12-1 and are transferred from the cellular phone 12-1 to the service device 14 in order to store them. Therefore, it is possible to display advertisement videos matching the preference of the user of the cellular phone 12-1. Further, by each communication, an advertisement video is changed, so that the cellular phone 12-1 can display a plurality of advertisement videos on the display 54, resulting in higher business value in advertisement service.

Further, in accordance with the communication system 1 of the present invention, while the cellular phone 12-1 is receiving advertisement videos from the service device 14, the cellular phone 12-1 displays a default advertisement video received from the Web server 24 previously. Therefore a period of no displaying advertisement video can be shrunk. Further, when the cellular phone 12-1 starts to communicate with the service device 14, the above default advertisement video is always displayed. This means that the default advertisement video is highly effective. Further, in accordance with the communication system 1 of the present invention, when the cellular phone 12-1 communicates with the Web server 24, the above default advertisement video is replaced. Therefore, various types of default advertisement video can be used.

Further, in the communication system 1, as described above, even when the cellular phone 12-1 is boosting an application program APL, the default advertisement video is displayed on the display 54. This also increases advertisement effect much more.

### Third Embodiment

In the above second embodiment, when the advertisement video and the digital content data are transferred from the service device 14 to the cellular phone 12-1, the combination of the advertisement video and the digital content data is fixed.

In the present embodiment, the service device 14 and the Web server 24 can have non-fixed combination of advertisement videos and digital content. This combination data is called combination data CON. This creates dynamic combination of advertisement videos and digital content.

In a certain case, depending on contents of digital content data, some advertiser may not wish some combination of digital content data and advertisement videos. Alternatively, there could be a case that the due date for portrait right expires regarding advertisement videos. To deal with these cases, the combination data CON is prepared. The combination data CON includes a plurality of combinations that may be allowed or rejected.

In the present embodiment, for example, when the cellular phone 12-1 or 12-2 downloads an application program APL through the APL downloading unit 32, it is necessary to store the above combination data CON in the memory 58 of the cellular phones 12-1 and 12-2. When digital content data is designated, the processing circuit 59 of the cellular phone 12-1 or 12-2 selects a combination of the digital content data and an advertisement video based upon the combination data CON.

Further, when the cellular phone 12-1 communicates with the service device 14 via R/W device 16, the service device 14 transfers optimum-timing combination data to the cellular phone 12-1. The cellular phone 12-1 or 12-2 displays an advertisement video based upon the default combination data for the first time. However, next time, the cellular phone 12-1 or 12-2 displays advertisement data based upon a new combination data received through communication with the service device 14.

At this time the cellular phone 12-1 or 12-2 displays an advertisement video on condition that the advertisement video is within advertisement due date. If the cellular phone 12-1 or 12-2 determines that the advertisement video is not within the advertisement due date, a default advertisement video is played. Further, if the cellular phone 12-1 or 12-2 determines that the default advertisement video is not within the advertisement due date, no video is displayed. Thus, since it is possible that an advertisement due date expires, the cellular phone 12-1 or 12-2 automatically changes a default advertisement video.

According to the present embodiment, as described above, the combination of advertisement videos and digital content data can be changed flexibly by updating the combination data CON for combining an advertisement video and digital content data. Therefore, advertisement videos can be associated with suitable digital content data, so that high advertisement effect is achieved.

### Fourth Embodiment

In the present embedment, the cellular phone 12-1 or 12-2 generates and stores content-transfer history data TD in which a history of digital content data transferred between the above two cellular phones and other cellular phones is recorded. The content-transfer history data TD is finally stored in the Web server 24.

Specifically, when the cellular phone 12-1 or 12-2 transfers digital content data to other cellular phone, and vice versa, its transfer history is added to the content-transfer history data TD stored in the memory 58.

When the cellular phone 12-1 or 12-2 accesses the Web server 24, the cellular phone 12-1 or 12-2 reads out the content-transfer history data TD and transfers it to the Web server 24. This transfer is performed, for example, at the time when an application program APL is downloaded, or when advertisement member registration is performed. When the cellular phone 12-1 or 12-2 transfers the content-transfer history data TD to the Web server 24, this transfer may be implemented after the original content-transfer history data has been changed to the upper-level category data. When the change to the upper-level category data is performed, for example, each ID of cellular phone is changed to classified ID that is classified to a given ID, or each due date is changed to a given period of the due date that covers a certain period of due data. Here, the classified ID is, for example, an ID assigned to a type of cellular phone.

By using the content-transfer history data TD, the Web server 24 can have a network of preference based upon the attributes of the digital content data.

The Web server 24 can store contact information within the attribute data by receiving and storing attribute data of the cellular phones 12-1 and 12-2. This enables the Web server 24 to build SNS such as personal contacts map.

The EC unit 37 of the Web server 24 sells products regarding digital content by using the SNS, so that customers get points in EC purchasing. In addition to these usual services, the EC unit 37 offers a service in which introducers also can get points.

When the content-transfer history data TD includes some digital content data such as “entertainer's photograph”, the above SNS is useful as an information network in selling EC goods regarding the entertainer. When an introducer succeeds in letting a registered member purchase goods, the Web server 24 can offer a system in which part of points given to the member is automatically shared to the introducer. Further, the EC unit 37 of the Web server 24 may also enable customers to purchase products from linked sites that appear in the advertisement videos displayed on the cellular phones 12-1 and 12-2. In this case, the Web server 24 may give points to the cellular phone 12-1 that presents product information. Further in this case, the Web server 24 may give points to cellular phones traced over several generations.

Further the Web server 24 may offer services in which people answer to a questionnaire presented on a network, taking advantage of a network of preference based upon digital content data. The Web server 24, if necessary, can get exact information from users who are sensitive to own preference regarding digital content by giving answerers points.

The present invention does not limited to the above-mentioned embodiments. Various modifications may be made without departing from the spirit and scope of the invention. Any improvement may be made in part or all of the components.

What is claimed is:

1. A service providing method using a mobile communication device having a short-range communication function, comprising the steps of:
a first step in which the mobile communication device transfers user's or the mobile communication device's attribute data stored in the mobile communication device to a service processing device by performing short-range communication with the service processing device installed at a predetermined place;
a second step in which the service processing device transfers the attribute data received in the first step and place data representing a place at which the service processing device is installed to a server via the mobile communication device or directly;
a third step in which the server selects recommendation data which is beforehand associated with the attribute data and place data received in the second step and transfers the selected recommendation data to the mobile communication device or the service processing device; and
a fourth step in which the mobile communication device or the service processing device performs announcement according to the recommendation data received in the third step.

2. The service providing method according to claim 1 further comprising:
a fifth step in which the mobile communication device conducts a questionnaire survey and changes the answered words in the resultant questionnaire into the words of upper level category based upon a correspondence table in which upper level concepts of each word are associated with lower level concepts of the word,
wherein the mobile communication device transfers the changed questionnaire data as the attribute data in the first step to the service processing device.

3. The service providing method according to claim 1,
wherein, in the third step, the server transfers IDs of a plurality of selected recommendation items to the service processing device, and in the fourth step, the service processing device transfers the IDs of a plurality of the recommendation items received in the third step to the mobile communication device via short-range communication, and the mobile communication device receives, from other devices, recommendation items corresponding to the IDs received in the fourth step based upon the attribute data, and performs announcement according to the recommendation data selected from the received recommendation data.

4. The service providing method according to claim 1 further comprising:
the sixth step in which the service processing device detects environment condition and generates environment data,
wherein, in the second step, the service processing device transfers the environment data generated in the sixth step to the sever, and in the third step, the server selects the recommendation data by using the environment data received in the second step.

5. The service providing method according to claim 1,
wherein, in the fourth step, the service processing device selects recommendation items from the plurality of the recommendation items received in the third step based upon a standard defined in the service processing device, and outputs the selected recommendation data, and the mobile communication device selects recommendation items from the plurality of recommendation items received in the third step based upon a standard defined in the mobile communication device, and outputs the selected recommendation data.

6. The service providing method according to claim 1,
wherein, in the fourth step, the service processing device displays advertisement images on a display of the service processing device according to the recommendation data received in the third step during communication with the mobile communication device,
and the mobile communication device displays advertisement images on a display of the mobile communication device during communication with the service processing device.

7. The service providing method according to claim 1, wherein at least one of the service processing device and the server selects recommendation data to be transferred to the mobile communication device and the service processing device based upon a history of the attribute data.

8. A service processing device comprising:
an interface that performs short-range communication with a mobile communication device directly or indirectly;
a memory that stores place data; and
a controller that receives attribute data of a user or user's mobile communication device from user's mobile communication device, transfers the attribute data and the place data read out from the memory to the server, and performs announcement based upon recommendation data corresponding to the place data received from the server.

9. The service processing device according to claim 8 further comprising:
an environment detecting device that detects environment condition in a place where the service processing device is installed and generates environment data,
wherein the controller transfers the place data and the environment data generated by the environment detecting device to the server, and receives recommendation data corresponding to the place data and the environment data from the server.

10. The service processing device according to claim 8,
wherein the controller changes the attribute data received by the interface into data of upper level category based upon a correspondence table in which upper level concepts of each word are associated with lower level concepts of the word, and transfers the changed attribute data to the server.

11. The service processing device according to claim 8 further comprising:
a display,
wherein the controller receives advertisement images and digital content data, which are associated with each other, as the recommendation data and transfers the advertisement images and digital content data to the memory;
and transfers the advertisement images selected from the memory based upon the attribute data received from the mobile communication device via the interface, and the digital content data associated with the advertisement images to the mobile communication device via the interface; and
displays on the display the advertisement images selected from the memory based upon the attribute data.

12. A mobile communication device for performing short-range-communication with a service processing device installed at predetermined place, the mobile communication device comprising:
a short-range communication interface that performs short-range-communication with the service processing device;
a memory that stores attribute data of a user or his mobile communication device; and
a controller that transfers the attribute data read out from the memory to the service processing device, receives recommendation data associated with the attribute data and a place of the service processing device, and performs announcement according to the recommendation data.

13. The mobile communication device according to claim 12,
wherein the controller conducts a questionnaire survey for users of the mobile communication device, changes the resultant answers in the questionnaire into words of upper level category, and transfers the changed questionnaire data as the attribute data to the service processing device.

14. The mobile communication device according to claim 12 further comprising:
a display,
wherein the memory further stores default advertisement images, and the controller receives advertisement images and digital content data associated with the advertisement images by performing short-range communication with the service processing device via the short-range communication interface and then stores the advertisement images and digital content data into the memory, and displays the default advertisement images on the display until completion of receiving the advertisement images from the service processing device via short-range communication, and displays the received advertisement images on the display after completion of receiving the advertisement images from the service processing device.

15. The mobile communication device according to claim 14,
wherein the controller changes the default advertisement images stored in the memory into default advertisement images received from the server during communication with the server via network communication means.

16. The mobile communication device according to claim 14,
wherein the controller transfers combination of the advertisement images and the associated digital content data to other mobile communication device.

17. The mobile communication device according to claim 16,
wherein the controller determines advertisement images to be displayed during use of the digital content data based upon combination data that is combinations of the advertisement images and the digital content items.

18. The mobile communication device according to claim 17,
wherein the controller updates content-transfer history data when transferring the advertisement images and digital content data to or from the mobile communication device, and transfers the content-transfer history data to the server during communication with the server which provides the advertisement images and the digital content data.

19. The mobile communication device according to claim 18,
wherein the server provides a predetermined service for a user group to which same or same type of digital content data is transferred via short-range communication based upon the content transfer history data received from the mobile communication device.

20. A mobile communication device according to claim 18,
wherein the controller changes the content transfer history data to upper level category data based upon correspondence table data in which upper level concept words of transfer history items are beforehand associated with lower level concept words,
and transfers the changed transfer history data to the server.

21. A server for providing information associated with a mobile communication device that performs short-range communication with a service processing device installed at a predetermined place, the server comprising:
an interface that receives attribute data of a user or his mobile communication device and place data of a place where the service processing device is installed from the mobile communication device or the service processing device;
a memory that stores recommendation data which is associated with the attribute data and the place data; and
a controller that reads out, from the memory, the recommendation data which is associated with the attribute data received by the interface and the place data, and transfers the recommendation data to the mobile communication device or the service processing device through the interface.

22. The server according to claim 21,
wherein the mobile communication device displays default advertisement images stored in the mobile communication device until completion of receiving advertisement images and digital content data associated with the advertisement images via short range communication with the service processing device,
and the controller changes the default advertisement images of the mobile communication device into the received advertisement images through network communication after the controller has completed reception of the advertisement images from the service processing device.
